(19) United States
(12) Patent Application Publication
(10) Pub. No.: US 2021/0167665 A1
(43) Pub. Date: Jun. 3, 2021

(54) DEVICE FOR THE INTERMITTENT OPERATION OF THE COOLING FAN OF THREE-PHASE INDUCTION MOTORS, CONTROLLED BY THE TEMPERATURE OF THE STATOR WINDING

(71) Applicant: CORPORACION UNIVERSIDAD DE LA COSTA, Barranquilla (CO)

(72) Inventors: Juan Jose CABELLO ERAS, Barranquilla (CO); Andres Gabriel SANCHEZ COMAS, Barranquilla (CO); Vladimir SOUSA SANTOS, Barranquilla (CO)

(21) Appl. No.: 17/265,779

(22) PCT Filed: Aug. 1, 2019
(86) PCT No.: PCT/IB2019/056582

§ 371 Date: Feb. 3, 2021

(30) Foreign Application Priority Data
Aug. 3, 2018 (CO) NC2018/0008244

(51) Int. Cl. H02K 9/06; H02K 5/20; H02K 7/108; H02K 11/25; H02K 11/30; H02K 17/12; H02P 29/64

(52) U.S. Cl. CPC H02K 9/06; H02K 5/207; H02K 7/108; H02K 11/25; H02K 2211/03; H02K 17/12; H02P 29/64; H02K 2205/09; H02K 11/30

(57) ABSTRACT

The object of the present invention is to provide a device that allows the intermittent operation of the cooling fan, with a mechanism controlled by the stator temperature, to reduce whipping losses and improve the operating efficiency of three-phase induction motors for industrial use, such as those that operate pumps, compressors, conveyors, fans, welding machines and die cutters, among others.

### BACKGROUND OF THE INVENTION

Electric motor driven systems represent between 43% and 46% of global electricity consumption and generate 6040 Mt of CO₂ emissions approximately every year. In the industrial field, motor consumption represents approximately 68% of total electric energy consumption. In the United States and the European Union, this consumption is between 65% and 75%, while in Canada it reaches 80%, demonstrating the importance of taking actions that reduce their energy consumption. Among the measures that have been taken are the improvement in designs and materials to reduce losses and improve efficiency, the appropriate selection according to the function performed, the improvement in the efficiency of the driving mechanisms, and the gradual replacement of standard efficiency motors by high efficiency motors.

The energy losses in three-phase induction motors are divided into copper losses of the stator and rotor, core losses, additional losses and friction and whipping losses, the latter produced by the cooling air fan. Among these, friction and whipping losses represent approximately 1.2% of electricity consumption, being very significant in large motors with a continuous operation (SI) regime of around 5000 hours per year.

Whipping losses are permanent because in induction motors, the cooling fan is fixed to the axis rotating next to it, although cooling is not always required. Several patents with an alternative to a conventional cooling mechanism have been published; however, they are very different from those proposed in this invention, as disclosed by patent No. JP4008899, which presents a cooling device for an electric motor with a unidirectional clutch that couples the cooling fan with the shaft while the motor is running and disengages the fan when the motor is turned off, allowing it to remain in rotation due to the inertia effect and to continue cooling the motor for an additional time after the shaft has stopped.

Another cooling mechanism, although for motors of the automobile steering system and not for three-phase motors, is the one disclosed in U.S. Pat. No. 5,557,930A, which comprises a device where the cooling fan is operatively connected to the motor by a clutch and is provided with a control circuit which has the function of operating the clutch that disengages the cooling fan when it is required to supply hydraulic fluid in the steering system.

In the field of motor clutches, U.S. Pat. No. 3,280,352 presents an automatic magnetic clutch brake to reduce braking inertia in an electric motor. The mechanism disengages the motor shaft from the inertial mass when the power supply is interrupted and engages the operation when the power supply is restored.

U.S. Pat. No. 4,868,437 discloses an assembly where the coupling between the shaft and the fan occurs based on the temperature of the rotor and a mechanical element of high thermal expansion.

In view of the above mentioned prior art documents, it is necessary to develop a device that reduces the whipping losses due to the ventilation system and improves the operation efficiency of the three-phase induction motors for industrial use.

Therefore, the present invention presents a device that allows the intermittent operation of the cooling fan, with a mechanism controlled by the stator temperature, and which also comprises a temperature data storage and communication system that allows diagnosis of failures, detection of operational changes or other applications.

### DESCRIPTION OF THE INVENTION

The object of the present invention is to provide a device that allows the intermittent operation of the cooling fan, with a mechanism controlled by the stator temperature, to reduce whipping losses and improve the operating efficiency of three-phase induction motors for industrial use as those that operate pumps, compressors, conveyors, fans, welding machines and die cutters among others.

The device for intermittent operation of the three-phase induction motor cooling fan controlled by the stator winding temperature is operated by sensing the temperature of the stator winding constantly, temperature that depends on the motor insulation system.

The device senses the stator winding temperature permanently and according to the motor insulation system, the controller compares the sensed temperature with a minimum and maximum temperature range. The fan remains disconnected if the stator winding temperature is below the minimum temperature or if it exceeds the minimum temperature but does not exceed the maximum temperature.

The fan is switched on if the stator winding temperature is higher than the maximum permissible temperature and is switched off only when the stator winding temperature is reduced to a temperature lower than the minimum permissible temperature.

The NEMA standard (National Electrical Manufacturers Association, Standard for Motors and Generators) establishes the design and construction features that three-phase induction electric motors must meet. Among these, the maximum permissible operating temperature is defined according to the class of the insulation system. To avoid continuous processes of switching on and off the device, a minimum temperature is set, 5° C. below the maximum operating temperature. The following table shows these temperature ranges. The insulation system class is shown on the motor nameplate.

TABLE 1
Maximum permissible operating temperature
according to the insulation system class.

| Insulation | Minimum permissible | Maximum permissible |
|---|---|---|
| system | operating temperature | operating temperature |
| Class | (° C.) | (° C.) |
| A | 70 | 75 |
| B | 90 | 95 |
| F | 110 | 115 |
| H | 125 | 130 |

The device can be adapted to a motor during its manufacture or exploitation and consists of a temperature sensor, a linear electric actuator, a thermostat that opens and closes the actuator power circuit and a mechanical coupling system between the fan and the motor shaft.

In a particular embodiment, the temperature sensor may be coupled to the motor stator winding and the thermostat together with the linear actuator to the motor casing. In this embodiment, the sensor measures the stator winding temperature and sends the corresponding signal to the thermostat so that it operates the linear actuator, arranged in the motor casing, and the coupling or disengagement of the fan is carried out.

In another particular embodiment, the sensor is in the stator winding, the controller in the control box and the linear actuator in the motor casing, such that once the sensor measures the stator winding temperature, it sends the signal to the controller, which in turn operates the linear actuator for the coupling or disengagement of the fan.

In a further particular embodiment, the thermostat is arranged in the motor stator winding to directly operate the linear actuator that is in the motor casing, thereby carrying out the coupling or disengagement of the fan.

In a last embodiment, the sensor is in the stator winding, the thermostat and the linear actuator in the motor casing and the controller in a control box, separate from the sensor, the thermostat and the linear actuator. In this embodiment, the motor stator winding sensor sends a signal to the thermostat so that it in turn operates the linear actuator and the fan is coupled or uncoupled, this sensor also sends a signal to the controller to activate the alarms, send the information to the external connector and the data transmission and storage module.

Additionally, in any of the previous embodiments, the device may optionally comprise a separate controller that activates the visual and audible alarm, sends sensed temperature information to the data transmission and storage module so that it in turn activates the data transmission antenna, and sends a signal to the external connector so that through it a device measures the stator winding temperature and the motor temperature is visualized through a data display module, all this optionally included in a control box.

### DESCRIPTION OF THE FIGURES

FIG. 1. Three-phase electric induction motor for industrial use.

FIG. 2. Side view of the three-phase electric induction motor for industrial use with coupling and re-position of the clutch mechanism.

FIG. 3. Side view of three-phase electric induction motor for industrial use

FIG. 4. Top view of the three-phase electric induction motor for industrial use with the control box.

FIG. 5. Enlarged view of the motor shaft coupling flange.

FIG. 6. Enlarged view of the fan coupling flange.

FIG. 7. Sectional view of the clutch mechanism.

FIG. 8. Exploded view of the fan side coupling mechanism.

FIG. 9. Exploded view of the motor side coupling mechanism.

FIG. 10. Intermittent operation of the motor cooling fan.

FIG. 11. Intermittent operation of the motor cooling fan where the temperature sensor is coupled to the motor stator winding and the thermostat together with the linear actuator to the motor casing.

FIG. 12. Intermittent operation of the motor cooling fan where the stator winding, thermostat and linear actuator are in the motor casing and the controller in a control box, separate from the sensor, thermostat and linear actuator.

FIG. 13. Intermittent operation of the motor cooling fan with a control box.

### DETAIL DESCRIPTION OF THE INVENTION

In order to provide a detailed description of the invention, the device for the intermittent operation of the cooling fan of a three-phase electric induction motor is described, based on the figures provided.

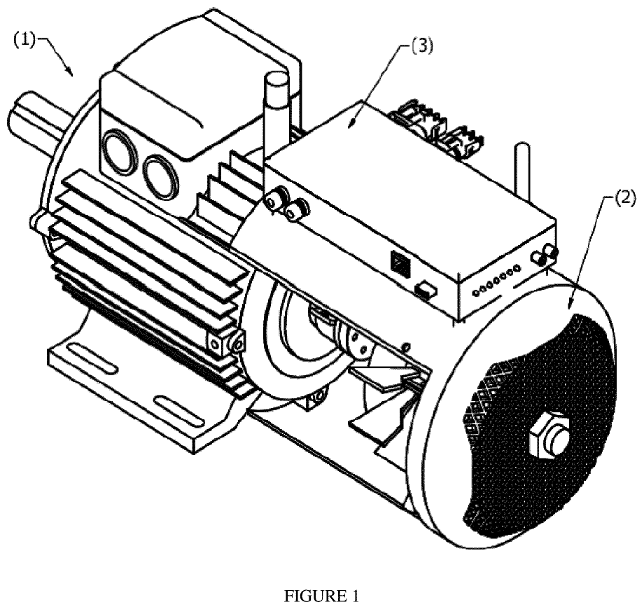

FIG. 1 shows the three-phase electric induction motor for industrial use consisting of a motor (1), a fan casing (2) and a control box (3).

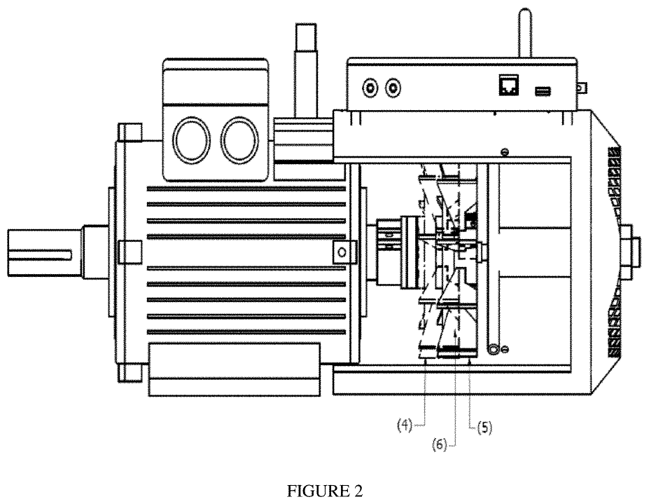

In FIG. 2, the coupling (4) and disengagement (5) position of the cooling fan (6) can be observed.

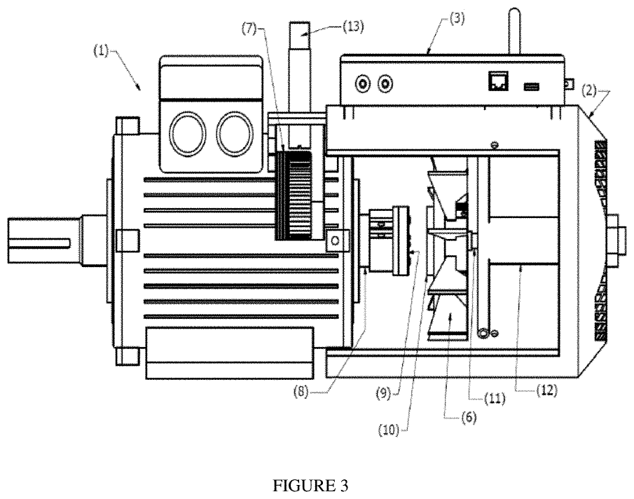

FIG. 3 shows the mechanical elements that allow the intermittent operation of the cooling fan. As can be seen, the motor shaft (8) and the cooling fan (6) are normally decoupled. These are coupled when the intermittent connection device of the cooling fan (6) is operated, by joining the shaft coupling flange (9) and the fan coupling flange (10). The fan coupling flange is assembled to the cooling fan (6), the linear actuator (11) and the actuator support (12). The intermittent coupling is operated according to the temperature measured by the temperature sensor (13) in the motor stator winding (7).

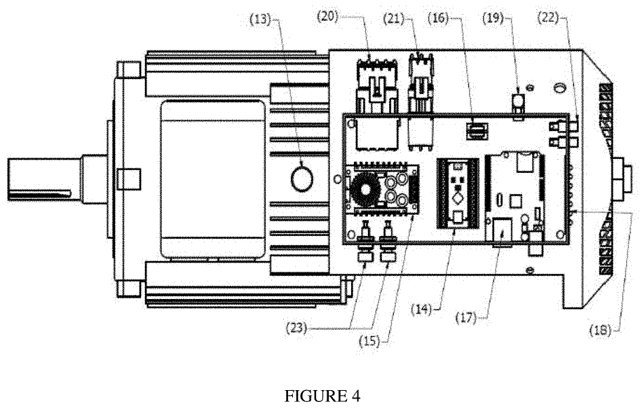

FIG. 4 shows the control box (3) with the electronic elements that allow the intermittent operation of the cooling fan. These elements, which are electrically connected to a conventional electronic board, allow collecting the temperature signal, processing the signal by comparison with the reference temperatures, and sending the operation signal to the mechanical elements of the device and the data storage and transmission. The electronic elements are: the controller (14), a DC power supply (15), a temperature range selector (16), a data transmission and storage module (17), a data display module (18), a data transmission antenna (19), the connector for the visual and audible alarm (20), the sensor connector (21), the external meter connectors (22) and the power supply connectors (23).

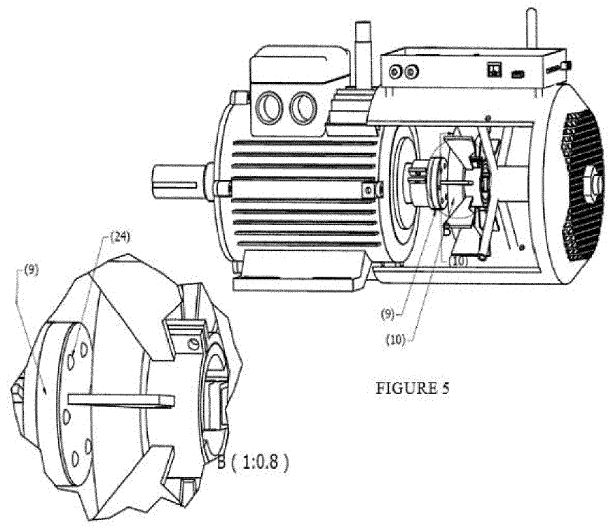

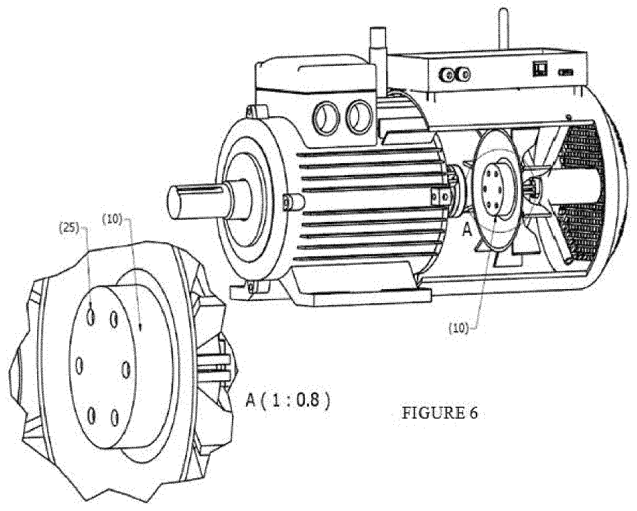

FIG. 5 shows the coupling flange of the motor shaft (9) with cylindrical geometric shape and some metal balls properly inserted (24) for assembly with the fan coupling shaft (10) shown in FIG. 6. The fan coupling flange (10) has geometric-shaped holes (25) identical to that of the balls (24) of the motor shaft coupling flange (9) (FIG. 5).

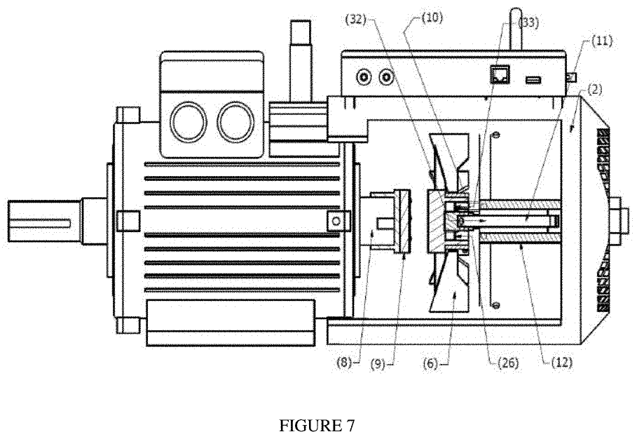

When the operating temperature reaches the maximum set temperature, the linear actuator (11) (FIG. 7) is engaged, pushing the flange that supports the cooling fan (10) axially towards the flange that is fixed to the shaft (9), producing the contact between the two flanges. In the first moments of the contact, friction is established for a short period of time, until the balls of the shaft flange (24) are introduced into the holes (25) of the flange that supports the cooling fan (10), the shaft being coupled with the cooling ventilation system.

FIG. 7 shows the linear actuator support (12) that externally supports and covers the linear actuator (11) up to a length of ¾ of the actuator length. The linear actuator is coupled to the inside of the fan bearing (26) and this in turn is fixed to the fan and the coupling flange.

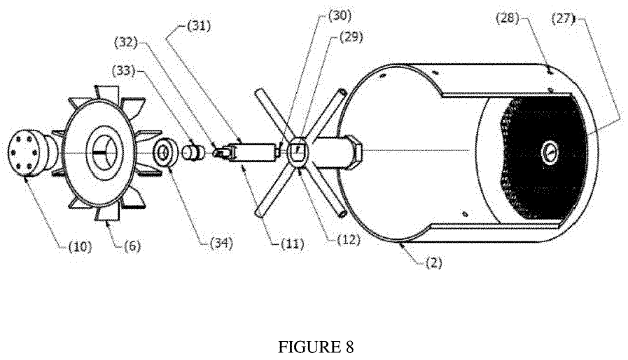

The linear actuator support (12), shown in FIG. 8, is fixedly coupled at one end through a circular hole (27) located at the rear of the casing (2), ensuring that the mechanism is concentric. At the other end there is also a fastening means composed of four or more supports fixed by means of screws in the side holes (28) of the casing. This allows a symmetric distribution along the circumference of the linear actuator support (29).

The linear actuator (11) is assembled inside the linear actuator support and comprises three sections. The first section has a cylindrical shape (30), the second section (31) is the longest and has a hexagonal shape as shown in FIG. 8, while the third section (32) has a cylindrical shape with a bypass that engages with the axis of the linear actuator (33). This in turn is introduced into the bearing (34).

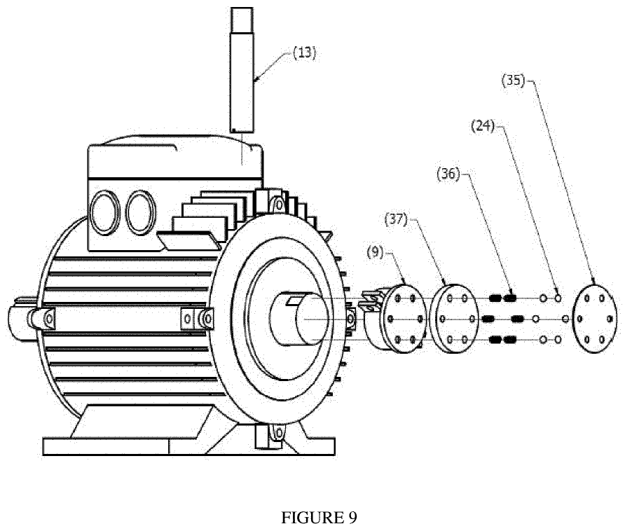

FIG. 9 shows the inside of the shaft flange (9) formed by the ball socket (35), the metal balls (24) and the springs (36) together with the spring socket (37). This flange is assembled to the motor shaft (8).

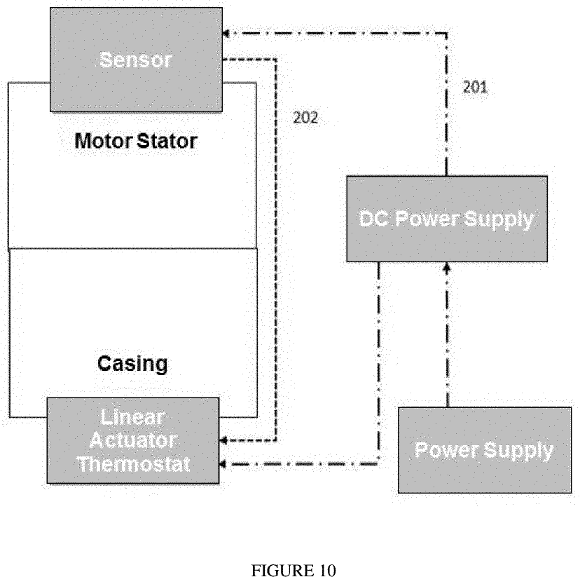

FIG. 10 illustrates the direction (201, 202) of the power supply and the signal of the device for intermittent operation of the linear actuator for intermittent coupling of the cooling fan of the three-phase induction motor controlled by the stator winding temperature, carried out by the thermostat by sensing the stator winding temperature constantly.

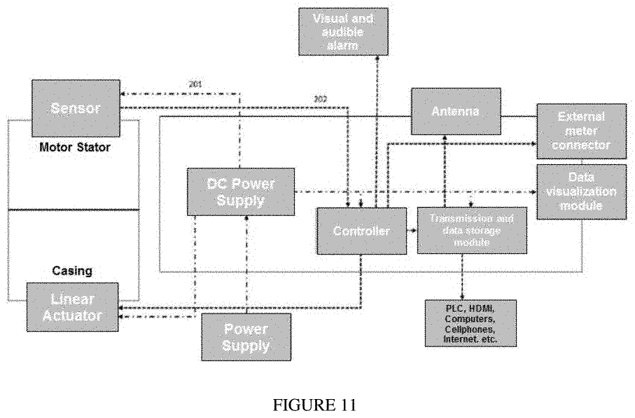

In the particular embodiment of FIG. 11, the temperature sensor is coupled to the motor stator winding and the thermostat together with the linear actuator to the motor casing. In this embodiment the sensor measures the stator winding temperature and sends the signal (202) to the thermostat so that it operates the linear actuator, arranged in the motor casing, and the fan is coupled or uncoupled.

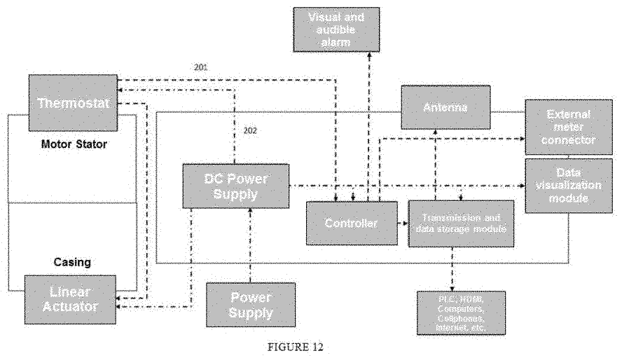

In the embodiment of FIG. 12, the sensor is in the stator winding, the thermostat and the linear actuator in the motor casing and the controller in a control box, separate from the sensor, the thermostat and the linear actuator. In this embodiment, the motor stator winding sensor sends a signal (202) to the thermostat so that it in turn activates the linear actuator and the fan is coupled or uncoupled, this sensor also sends a signal (202) to the controller so that it activates the alarms, sends the information to the external connector and to the data transmission and storage module.

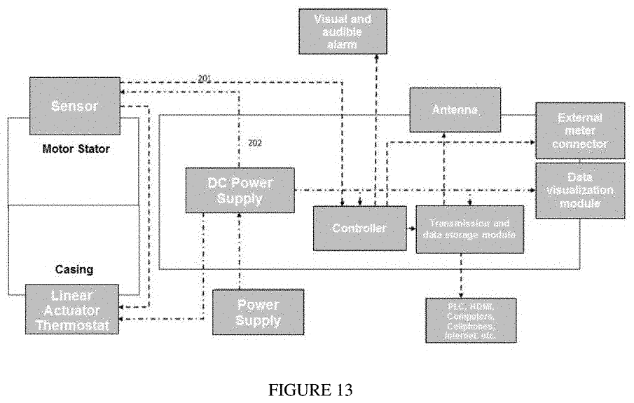

Additionally, in any of the above embodiments, the device may optionally comprise a separate controller that activates the visual and audible alarm, which sends sensed temperature information to the data transmission and storage module so that it in turn activates the data transmission antenna, and sends a signal (202) to the external connector so that through it a device measures the stator winding temperature and it is displayed through a motor temperature data display module, all optionally included in a control box (see FIG. 13).

1. A device for intermittent operation of the cooling fan of a three-phase electric induction motor comprising:
A clutch mechanism between the fan (6) and the motor shaft consisting of two flanges, the first one, the shaft coupling flange (9), mounted on the motor shaft (8) configured to rotate next to the motor, and;
The coupling flange (10), coupled to the fan (6) and an actuator fixed to the rear motor casing (2);
A linear electric actuator (11) where the clutch mechanism engages and disengages the cooling fan (6) with the motor shaft (8);
A temperature sensor (13) placed in the motor stator winding (7);
A thermostat that responds to the temperature sensor (13) installed in the motor stator winding (7) and comes into contact with the linear actuator (11).

2. A device for intermittent operation of the cooling fan of a three-phase electric motor according to claim 1, wherein the shaft coupling flange (9) also has metal balls (24) supported by springs incorporated into its surface.

3. A device for intermittent operation of the cooling fan of a three-phase electric motor according to claim 1, wherein the fan coupling flange (10) has on its surface spherical cavities (26) in accordance with the balls (24) of the first flange.

4. A device for intermittent operation of the cooling fan of a three-phase electric motor according to claim 1, wherein the control box (3) comprises a controller (14), a DC power supply (15), a temperature range selector (16), a data transmission and storage module (17), a data display module (18), a data transmission antenna (19) and four connectors (20), (21), (22), (23). These devices are electrically connected on a conventional electronic board.

5. A device for intermittent operation of the cooling fan of a three-phase electric motor according to claim 4, wherein the connectors are derived from the group comprising the connector for the visual and audible alarm (20), the sensor connector (21), the external meter connectors (22) and the power supply connectors (23).

6. A device for intermittent operation of the cooling fan of a three-phase electric motor according to claim 5, wherein the power supply connector (23) is coupled by mounting the fan mechanism casing (2) with the motor casing (2), wherein additionally the wired connection of the temperature sensor (13) installed in the motor stator winding (7) is connected to the thermostat and the data transmission and storage module (17).

7. A device for intermittent operation of the cooling fan of a three-phase electric motor according to claim 4, wherein the data transmission and storage module (17) that is inside the control box (3), comprises a memory, a wireless and Ethernet systems for storing, obtaining and transmitting temperature data.

8. A device for intermittent operation of the cooling fan of a three-phase electric motor according to claim 4, wherein the signaling module indicates the operating temperature range and the coupling or decoupling of the system.

9. A device for intermittent operation of the cooling fan of a three-phase electric motor according to claim 4, wherein the temperature range selector selects a temperature according to the motor insulation system and sets the operating temperature range of the thermostat.

10. A device for intermittent operation of the cooling fan of a three-phase electric motor according to claim 4, wherein the controller is connected to a monitoring center via wired and wireless communication lines that activate a visual or audible alarm, when the motor is exceeding the temperature range.

11. A device for intermittent operation of the cooling fan of a three-phase electric motor according to claim 1, wherein the fan coupling mechanism comprises the coupling flange (10), the fan (16), the fan bearing (26), the linear actuator shaft (33), the linear actuator (11) and the linear actuator support (12) assembled together inside the casing (2).

12. A device for intermittent operation of the cooling fan of a three-phase electric motor according to claim 1, wherein the motor shaft coupling mechanism comprises the engagement of the metal balls (35), the metal balls (24) and the springs (36) together with the spring fitting (37) and the shaft coupling flange (9) assembled to the motor shaft (8).

13. The device for intermittent operation of the cooling fan of a three-phase electric induction motor according to claim 1, wherein:
the temperature sensor is coupled to the motor stator winding;
the thermostat and linear actuator are coupled to the motor casing;
where the sensor measures the stator winding temperature and sends the signal to the thermostat, so that it in turn operates the linear actuator and the fan is coupled or disengaged.

14. The device for intermittent operation of the cooling fan of a three-phase electric induction motor according to claim 1, wherein:
the temperature sensor is coupled to the motor stator winding;
the controller is in the control box; and
the linear actuator is arranged in the motor casing;
where the sensor measures the stator winding temperature, the signal is sent to the controller and the linear actuator that couples or uncouples the fan is activated.

15. The device for intermittent operation of the cooling fan of a three-phase electric induction motor according to claim 1, wherein:
the thermostat is arranged in the motor stator winding,
the linear actuator that couples or disengages the ventilation is located in the motor casing.

16. The device for intermittent operation of the cooling fan of a three-phase electric induction motor according to claim 1, wherein:
the temperature sensor is coupled to the motor stator winding;
the thermostat and the linear actuator are arranged in the motor casing;
the controller is in the control box; separated from the sensor, thermostat and linear actuator;
wherein the stator winding sensor sends the signal to the thermostat and the actuator couples or uncouples the fan; In addition, the sensor sends a signal to the controller and the controller activates the alarms, sends information to the external connector and to the data transmission and storage module.

17. A method of measuring temperature for operating the cooling fan of the electric motor comprising:
a. collecting information from the motor insulation system;
b. measuring the stator winding temperature (7) permanently;
c. according to the information of the motor insulation system, comparing the sensed temperature with the maximum and minimum permissible temperature range with the controller;
d. coupling or de-coupling the cooling fan (6) from the motor shaft (8) through the clutch mechanism, where it remains uncoupled if the stator winding temperature (7) is below the maximum allowable temperature. If the stator winding temperature is higher than the maximum allowable temperature, the fan is coupled (6) and will remain in this state as long as the temperature is higher than the minimum permissible temperature.

18. A temperature measurement method for driving the electric motor cooling fan according to claim 13, comprising:
a. measuring the temperature with the thermostat on the motor stator winding, which comes into contact with the linear actuator (11) and is connected to the display module through the controller;
b. closing the actuator power circuit when the sensor registers a temperature greater than the upper limit of the established working range;
c. coupling the fan:
d. opening the circuit that feeds the linear actuator;
e. switching off the fan when the sensor registers a temperature below the lower limit of the set temperature range.
